(19) United States
(12) Patent Application Publication
(10) Pub. No.: US 2006/0055668 A1
(43) Pub. Date: Mar. 16, 2006

(54) Thin remote controller

(75) Inventor: Sharming Lin, Chung Ho City (TW)

Correspondence Address: BACON & THOMAS, PLLC, 625 SLATERS LANE, FOURTH FLOOR, ALEXANDRIA, VA, 22314, US

(73) Assignee: FORMOSA21 INC., Chung Ho City (TW)

(21) Appl. No.: 11/036,126

(22) Filed: Jan. 18, 2005

(30) Foreign Application Priority Data
Sep. 13, 2004 (TW) 093214574

(51) Int. Cl. G09G 5/00

(52) U.S. Cl. 345/156

(57) ABSTRACT

The thin remote controller of the present invention can have the size of a standard-sized PCMCIA card, and so the thin remote controller can be inserted into a PCMCIA slot of the notebook computer. Therefore, the user can remove the thin remote controller from the slot and use it as both a remote and a laser pen, or insert it back into the PCMCIA slot for storage. Accordingly, the present invention utilizes the key set to wirelessly control the notebook computer to control the operating system or to support multimedia programs and functions. Furthermore, the present invention provides the laser module to replace a laser pen.

### BACKGROUND OF THE INVENTION

1. Field of the Invention

The present invention relates to a thin remote controller and, more particularly, to a thin remote controller with a laser pointer.

2. Description of the Related Art

With technological improvements, notebook computers have gradually replaced traditional personal computers. As notebook computers have been developed to support various functionalities, special remotes for notebook computers have also been developed.

However, standard remotes for notebook computers are large in size, and so can not be attached onto the notebook computer. As a result, there is no proper storage space for these remotes. Furthermore, the typical remote for a notebook computer does not have a laser pointer, and so the user must use an extra laser pen in meetings or presentations. Moreover, new notebook computers are used not only for data editing purposes, but also for multimedia purposes; however, the standard remote for the notebook computer does not have multimedia support, which is very inconvenient for the user.

Therefore, it is desirable to provide a thin remote controller with a laser pointer for a notebook computer to mitigate and/or obviate the aforementioned problems.

### SUMMARY OF THE INVENTION

A thin remote controller of the present invention comprises a thin case, a laser module, a wireless signal transmitting module, a power device, a control circuit board, and a key set. The thin case comprises an opening on a top surface, and having an inner space concavely in opening, the thin case further comprising a front side edge having a laser light projection opening and a wireless signal transmitting opening. The laser module comprises a laser light source, the laser module disposed inside the inner space of the thin case, and the laser light source being correspondingly aligned with the laser light projection opening. The wireless signal transmitting module comprises a wireless signal transmitting source, the wireless signal transmitting module is disposed inside the inner space of the thin case, and the wireless signal transmitting source is correspondingly aligned with the wireless signal transmitting opening. The power device and the control circuit board are both disposed inside the inner space of the thin case, and the control circuit board is electrically connected to the laser module, the wireless signal transmitting module, and the power device. The key set is also electrically connected to the control circuit board and mounted on the top surface of the thin case, the key set comprises a laser light switch button and a plurality of control buttons. Wherein, the laser light switch button used to control the laser light source, and the plurality of control buttons used to control wireless control signal, and the control signal can be setup to correspond to multimedia software, such as PowerPoint, to change a presentation page.

The thin remote controller of the present invention has the size of a standard-sized PCMCIA card, and so the thin remote controller can be inserted into a PCMCIA slot of the notebook computer. Therefore, the user can remove the thin remote controller from the slot and use it as both a remote and a laser pen, or insert it back into the PCMCIA slot for carrying conveniently.

Accordingly, the present invention utilizes the key set 6 to wirelessly control the notebook computer 300 to control the operating system or to support multimedia programs and functions. Furthermore, the present invention provides the laser module 2 to replace a laser pen.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a preferred embodiment according to the present invention.

FIG. 2 is an exploded view of the preferred embodiment according to the present invention.

FIG. 3 illustrates the present invention applied with a notebook computer.

### DETAILED DESCRIPTION OF THE PREFERRED EMBODIMENT

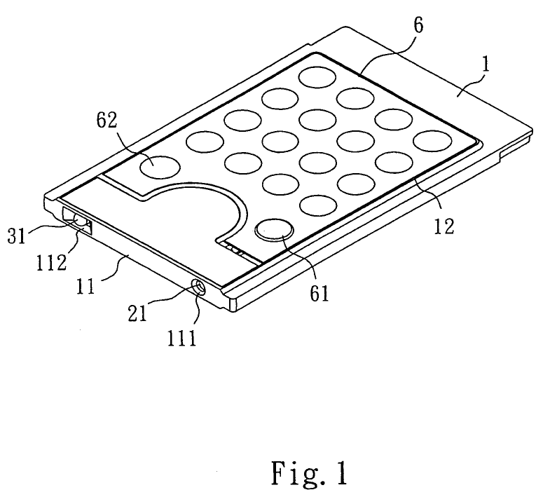

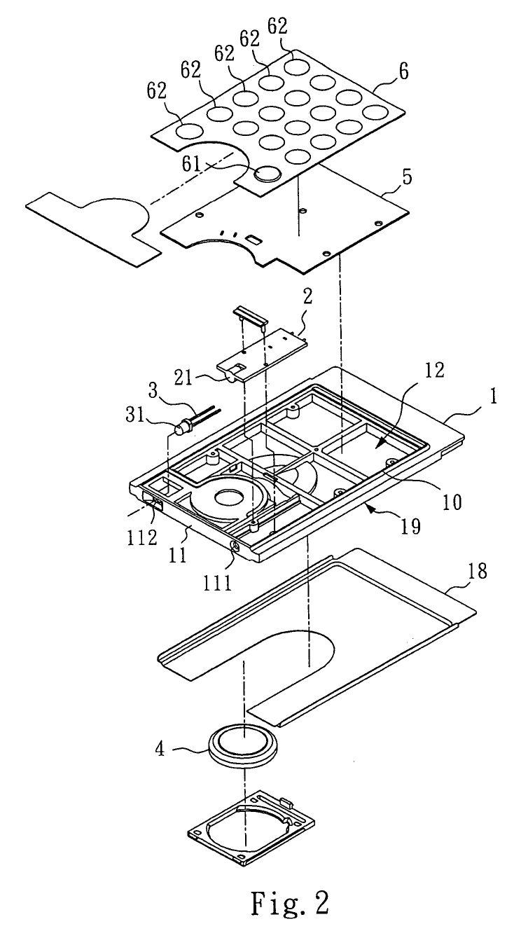

Please refer to FIG. 1 and FIG. 2. FIG. 1 is a perspective view of a preferred embodiment according to the present invention. FIG. 2 is an exploded view of the preferred embodiment according to the present invention. A thin remote controller of the present invention comprises a thin case 1, a laser module 2, a wireless signal transmitting module 3, a power device 4, a control circuit board 5, and a key set 6. In a preferred embodiment, the thin case 1 has a opening on a top surface 10, and an inner space 12 concavely; the thin case 1 further comprises a front side edge 11 having a laser light projection opening 111 and a wireless signal transmitting opening 112. Furthermore, thin case 1 further comprises a back cover 18 mounted on a bottom surface 19 of the thin case 1; in this embodiment, the back cover 18 can be metallic material or other metal-related material.

The laser module 2 comprises a laser light source 21. The laser module 2 is disposed within the inner space 12 of the thin case 1, and the laser light source 21 is correspondingly aligned with the laser light projection opening 111 to enable laser light from the laser light source 21 to pass through the laser light projection opening 111. Consequently, a user can use the thin remote controller as a laser pen.

The wireless signal transmitting module 3 comprises a wireless signal transmitting source 31. The wireless signal transmitting module 3 is disposed within the inner space 12 of the thin case 1, and the wireless signal transmitting source 31 is correspondingly aligned with the wireless signal transmitting opening 112. In this embodiment, the wireless signal transmitting module 3 is an infrared light source module, and the wireless signal source is an LED by the wireless signal transmitting source 31. Therefore, the user can utilize an infrared light transmission protocol to control a notebook computer 300. The wireless signal transmitting module 3 can also utilize RF, sonic, Bluetooth, or 802.11 series technologies for the wireless transmission protocol.

The power device 4 is contained within the inner space 12 of the thin case 1; in the preferred embodiment, the power device 4 is a lithium battery, such as a CR2032 battery or any other equivalent battery. The control circuit board 5 is also contained within the inner space 12 of the thin case 1 and is electrically connected to the laser module 2, the wireless signal transmitting module 3, and the power device 4.

In this embodiment, the key set 6 is a thin film switch, which reduces the thickness of the entire remote. The thin film switch is electrically connected to the control circuit board 5, and is mounted on the top surface 10 of the thin case 1. The key set 6 further comprises a laser light switch button 61 and a plurality of control buttons 62. The user may use the laser light switch button 61 to control the laser light source 21, and the plurality of control buttons 62 to control the notebook computer to utilize an operating system (OS) or change the settings of the OS (such as Windows). Furthermore, the control signals can be setup to correspond to multimedia software, such as PowerPoint, to change a presentation page, or to provide support for other multimedia player programs in the notebook computer.

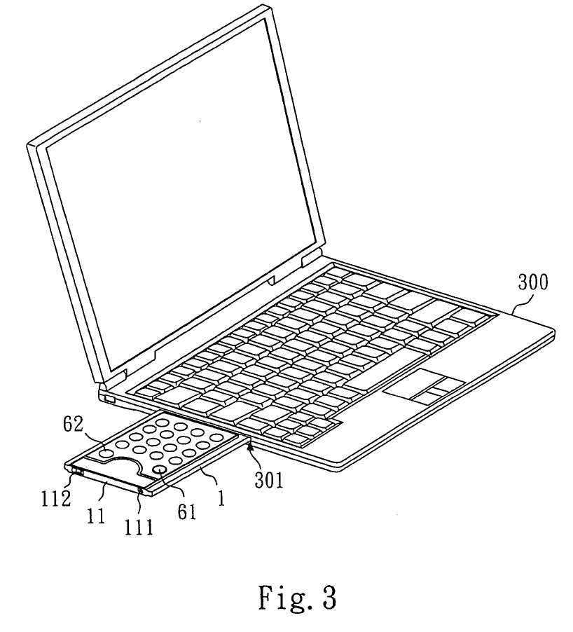

Please refer to FIG. 3. FIG. 3 shows the present invention as applied with a notebook computer. As shown in FIG. 3, the thin remote controller of the present invention can have the size of a standard-size PCMCIA card, and so the thin remote controller can be inserted into a PCMCIA slot 301 of the notebook computer 300. Therefore, the user can remove the thin remote controller from the slot and use it as both a remote and a laser pen, or insert it back into the PCMCIA slot 301 for carrying conveniently.

Accordingly, the present invention utilizes the key set 6 to wirelessly control the notebook computer 300 to control the operating system or to support multimedia programs and functions. Furthermore, the present invention provides the laser module 2 to replace a laser pen.

Although the present invention has been explained in relation to its preferred embodiment, it is to be understood that many other possible modifications and variations can be made without departing from the spirit and scope of the invention as hereinafter claimed.

What is claimed is:

1. A thin remote controller comprising:
a thin case comprises an opening on a top surface, and an inner space concavely in said opening, the thin case further comprising a front side edge having a laser light projection opening and a wireless signal transmitting opening;
a laser module comprising a laser light source, the laser module disposed inside the inner space of the thin case, and the laser light source being correspondingly aligned with the laser light projection opening;
a wireless signal transmitting module comprising a wireless signal transmitting source, the wireless signal transmitting module disposed inside the inner space of the thin case, and the wireless signal transmitting source correspondingly aligned with the wireless signal transmitting opening;
a power device disposed inside the inner space of the thin case;
a control circuit board disposed inside the inner space of the thin case, the control circuit board being electrically connected to the laser module, the wireless signal transmitting module, and the power device; and
a key set electrically connected to the control circuit board and mounted on the top surface of the thin case, the key set comprising a laser light switch button and a plurality of control buttons.

2. The thin remote controller as claimed in claim 1, wherein an external size of the thin remote controller is a standard size of PCMCIA card.

3. The thin remote controller as claimed in claim 1, wherein the key set is a thin film switch.

4. The thin remote controller as claimed in claim 1, wherein the thin case further comprises a back cover mounted on a bottom surface of the thin case.

5. The thin remote controller as claimed in claim 1, wherein the wireless signal transmitting module is an infrared light transmitting module, and the wireless signal source is an infrared light source.

6. The thin remote controller as claimed in claim 5, wherein the infrared light source is a LED.

7. The thin remote controller as claimed in claim 1, wherein the power device is a lithium battery.
